(19) United States
(12) Patent Application Publication
(10) Pub. No.: US 2013/0341389 A1
(43) Pub. Date: Dec. 26, 2013

(54) PERSONAL IDENTIFIER USEFUL FOR BAGGAGE ROUTING DURING TRAVEL

(71) Applicants: Ben O'Connor Roderique, Forest, VA (US); Kelly Pierre Roderique, Sicklerville, NJ (US)

(72) Inventors: Ben O'Connor Roderique, Forest, VA (US); Kelly Pierre Roderique, Sicklerville, NJ (US)

(21) Appl. No.: 13/528,831

(22) Filed: Jun. 20, 2012

(51) Int. Cl. G06F 17/30

(52) U.S. Cl. 235/375

(57) ABSTRACT

A barcode tag is affixed to any baggage that needs to be checked and may be left on permanently. The barcode can be linked to an individual's itinerary by a variety of means including a database having personal information, frequent flier number or unique ID number. If a passenger uses the self check in kiosk, they can check in their bags by scanning the barcode of the baggage and print their boarding pass. If completing self check in on a computer or Smartphone, the passenger can input the barcode into the Smartphone or computer and print their boarding pass. Either way, at the airport, the passenger could simply drop their bags off and continue on your way without delay. The barcode tag can be used for other applications, such as for providing user identity verification, for conducting financial transactions, and the like.

### BACKGROUND OF THE INVENTION

The present invention relates to personal identification systems and, more particularly, to a personal universal barcode linked to an individual's travel itinerary for the purpose of baggage routing.

Airlines are increasingly going to self check in at airports to eliminate the cost of material, labor and time associated with the passenger check in process. As a first example, a customer can walk up to a kiosk and print out their boarding pass but they cannot print out the baggage tag. They must still wait in line to receive the tag, therefore negating the benefit of self check in. In a second example, a customer will do self-check on their computer or smart phone, which allows them to print out a boarding pass to take with them or receive a QR code on their smart phone to be used as the boarding pass, but if they have to check baggage, they must get in line and wait to receive their baggage tag, again negating the time benefit of self check in. The third problem is the amount of money spent by airlines on disposable plastic tags and the equipment required to produce the tags.

As can be seen, there is a need for a paperless method to allow passengers to check bags without interacting with airline personnel to acquire a plastic tag, resulting in a method that allows for a true complete self check in process.

### SUMMARY OF THE INVENTION

In one aspect of the present invention, an identification system comprises a computerized system for assigning a unique personal universal barcode identifier to a user; a database storing the personal universal barcode identifier and personal identification information for the user; and a computerized information retrieval system for looking up data associated with the personal universal barcode identifier, wherein the personal universal barcode identifier is provided as a scan-able image to the user.

In another aspect of the present invention, a method for tracking items comprises assigning a unique personal universal barcode identifier to a user; storing the unique personal universal barcode identifier and information about the user in a database; providing the user with a placard having the personal universal barcode identifier printed thereupon; disposing the placard on the items; and looking up information about the user when the personal universal barcode identifier is entered into a database search request.

In a further aspect of the present invention, a method for tracking baggage during travel comprises assigning a unique personal universal barcode identifier to a user; storing the unique personal universal barcode identifier and information about the user in a database; providing the user with a placard having the personal universal barcode identifier printed thereupon; disposing the placard on the baggage; electronically attaching the personal universal barcode identifier to a travel itinerary of the user; looking up information about the user when the personal universal barcode identifier is entered into a database search request; and tracking each time the check-in bags are scanned during a travel itinerary.

These and other features, aspects and advantages of the present invention will become better understood with reference to the following drawings, description and claims.

### BRIEF DESCRIPTION OF THE DRAWINGS

FIG. 1 is a perspective view of a user's luggage, having a personal universal barcode displayed thereupon, according to an exemplary embodiment of the present invention;

FIG. 2 is a flow chart describing the use of a personal universal barcode for baggage routing during travel, according to an exemplary embodiment of the present invention; and

FIG. 3 is a flow chart describing the use of a personal universal barcode for transaction and identification purposes, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a barcode tag affixed to any baggage that needs to be checked and may be left on permanently. The barcode can be linked to an individual's itinerary by a variety of means including, but not limited to, a database having personal information, frequent flier number or unique ID number. If a passenger uses the self check in kiosk, they can check in their bags by scanning the barcode of the baggage and print their boarding pass. They can now drop the bag off and continue on their way without having to wait for airline personnel or the physical printing of a plastic tag. If completing self check in on a computer or Smartphone, the passenger use the Smartphone or computer to capture the barcode or manually type in the barcode numbers. After arriving at the airport, the passenger would drop bags off and continue on your way without delay. The system of the present invention would eliminate the need for plastic tags and the delay associated with acquiring them.

There is currently no paperless method to allow passengers to check bags without interacting with airline personnel to acquire a plastic tag. The system of the present invention provides such a system, reducing lines and the time involved in checking in at the airport.

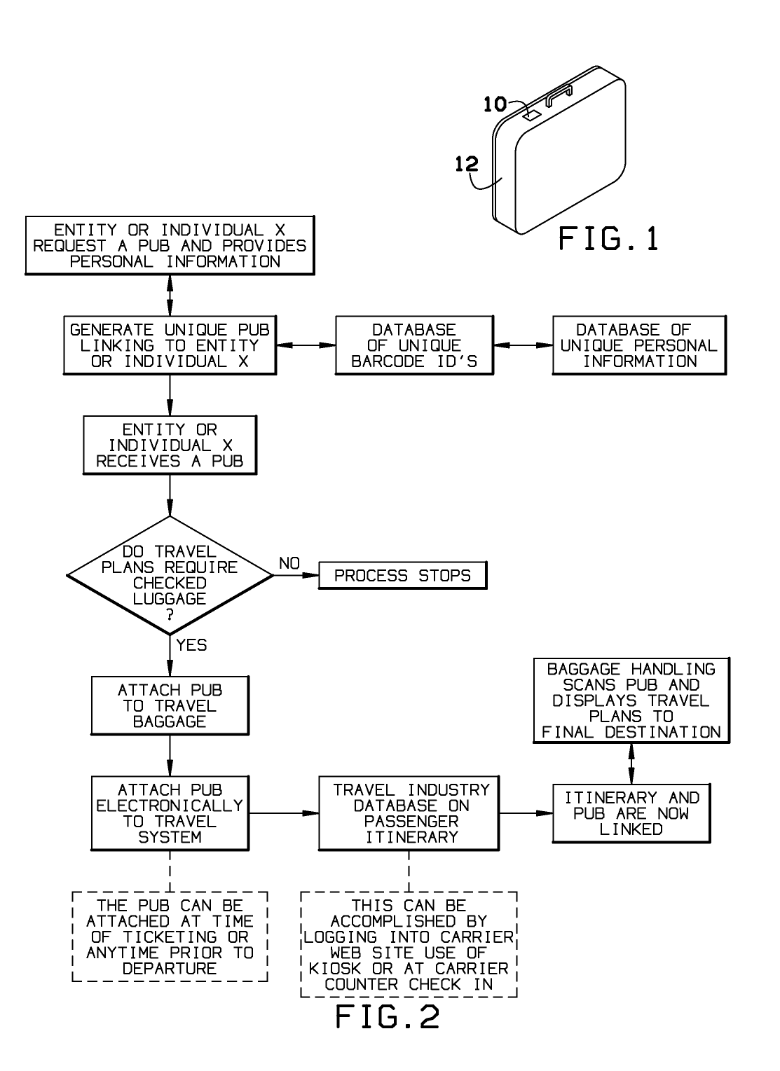

Referring to FIG. 1, a passenger's bag 12 may include a personal universal barcode 10 (PUB) affixed thereto. The PUB 10 may be provided in various mechanisms, including one or more of a sequence of numbers, a two-dimensional barcode, a three-dimensional bar code, a QR code, or the like. The PUB 10 may be affixed to the bag 12 by various means, including by adhesive, by a separate hanging member attached to the bag 12 and the PUB 10 (such as a chain, wire, or the like), or by other various mechanisms. In some embodiments, the PUB may be disposed on the outside of the bag 12, as shown in FIG. 1, and a backup PUB may be disposed inside the bag 12 to provide tracking if the PUB 10 outside of the bag 12 is lost or damaged.

The PUB may be linked to a PUB database that ensures that each PUB is unique. The PUB database may be disposed on one or more computing systems and can be accessed by various means, such as through the internet, through a local or wide area network, or the like. The data in the database may be stored on one or more server computers or on a cloud-based storage, for example. The PUB can contain unique identifying information that indicates the PUB is legitimate and comes from the PUB database.

Referring now to FIG. 2, a user (an entity or individual) can request a PUB by providing the necessary personal information. Typically, this request can be made through an online portal, such as via the internet. The system of the present invention can generate a unique PUB that links the entity or individual to thereto. This PUB is then assigned to the user and stored in the PUB database. The PUB may be sent to the user in various forms, such as a placard to be attached to bags, for example.

When the user makes travel arrangements, and requires checked luggage, the user can attach the PUB to their baggage and, when making the reservation, electronically “attach” the PUB to their itinerary in the travel system. The travel carrier would have an additional data field that would allow for PUB to itinerary correct correlation in the carrier database to ensure PUB tagged baggage and travel routing matching.

If the user does not have a PUB at the time of booking, the user may electronically attach their later acquired PUB to an existing itinerary at the time of ticketing or any time prior to departure. To electronically attach their PUB to an itinerary, a user can log into the carrier's website prior to departure to make the attachment, or may scan in the PUB at the airline's self check in kiosk at the airport. In some embodiments, the PUB can be linked to a user's frequent flyer number. The PUB can be printed on the user's boarding pass, providing an additional link between the baggage and the PUB. This link can be used as a security measure to ensure that each person is taking away only bags that belong to them.

Typically, a single PUB is assigned to a single user and the same PUB can be used on any number of bags. During baggage handling at the airport, baggage handlers may be given a scanner that can scan the PUB to determine proper baggage routing. Scanning of a bag may provide scanned bag information to a baggage tracking database. Should a bag not make it to its destination, a user can sign into their account and track the bag scans to find out the last place their bag was scanned. This can be used to help recover lost bags.

Various information can be made available to users, depending on their authorization. For example, baggage handlers may be able to see the baggage routing information, baggage lost and found may be able to see the user's registered name and address, for example.

In some embodiments, the PUB data can be mined for certain information to provide travel agents and the like with data to assist the traveler with additional travel-related options, such as hotels, rental cars, tickets to events, and the like.

In some embodiments of the present invention, the PUB can be used to provide end user identity shielding for a variety of transactions, including financial, whereby users can link credit cards and financial reserves against the PUB. An example would be baggage fees that could be automatically deducted from the reserves while transacting the baggage during booking. To prevent identity theft, any and all financial transactions can shield the end user personal information during a final transaction by using the PUB.

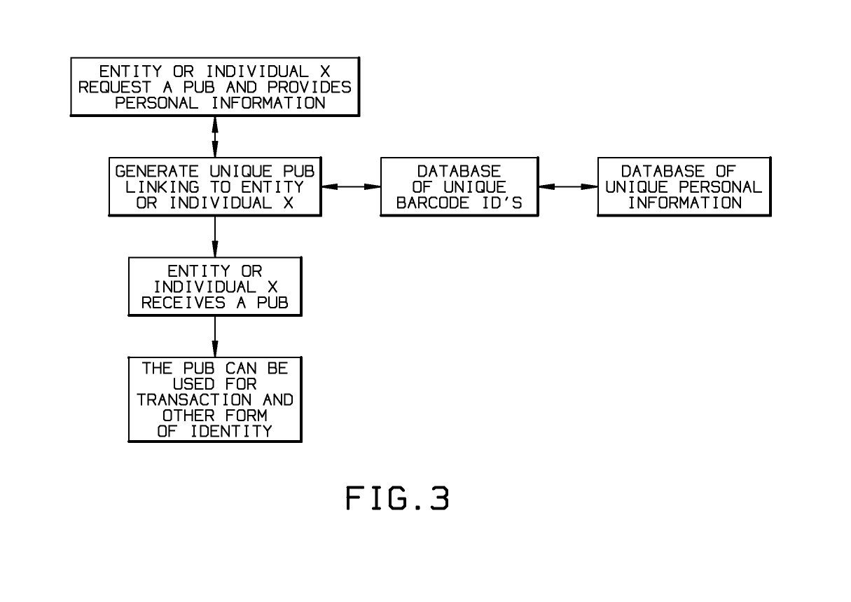

The ability in today's wireless electronic age to have a PUB assigned to an individual or entity has untold uses outside of travel. The social security number was never intended to be a personal tracking identifier; however it is a requirement for many processes today. The PUB can be used in some of the same processes with one difference in that a social security number is assigned for life, but the PUB can be assigned temporarily or only as long as an individual or entity pays for it. For example, the PUB can become the mobile equivalent of the social security card for many transactions. The PUB can be attached to personal belongings and if lost, the person finding it can log onto website and get access to limited information that would allow the personal belongings to be returned. FIG. 3 shows, schematically, the use of the PUB for various transaction or identity purposes outside of travel-related purposes.

It should be understood, of course, that the foregoing relates to exemplary embodiments of the invention and that modifications may be made without departing from the spirit and scope of the invention as set forth in the following claims.

What is claimed is:

1. An identification system comprising:
a computerized system for assigning a unique personal universal barcode identifier to a user;
a database storing the personal universal barcode identifier and personal identification information for the user; and
a computerized information retrieval system for looking up data associated with the personal universal barcode identifier,
wherein the personal universal barcode identifier is provided as a scan-able image to the user.

2. The identification system of claim 1, a computerized system for scanning the barcode identifier at an airport to determine baggage routing.

3. The identification system of claim 1, wherein the computerized information retrieval system provides a user's name and contact information to aid in recovery of lost items having the personal universal barcode identifier applied thereto.

4. A method for tracking items comprising:
assigning a unique personal universal barcode identifier to a user;
storing the unique personal universal barcode identifier and information about the user in a database;
providing the user with a placard having the personal universal barcode identifier printed thereupon;
disposing the placard on the items; and
looking up information about the user when the personal universal barcode identifier is entered into a database search request.

5. The method of claim 4, wherein the items are check-in bags for travel.

6. The method of claim 5, further comprising tracking each time the check-in bags are scanned during a travel itinerary.

7. The method of claim 5, wherein the items information looked up includes a travel itinerary for the user.

8. The method of claim 5, further comprising electronically attaching the personal universal barcode identifier to a travel itinerary of the user.

9. The method of claim 8, further comprising printing the personal universal barcode identifier on a boarding pass of the user.

10. A method for tracking baggage during travel comprising:
assigning a unique personal universal barcode identifier to a user;
storing the unique personal universal barcode identifier and information about the user in a database;
providing the user with a placard having the personal universal barcode identifier printed thereupon;
disposing the placard on the baggage;
electronically attaching the personal universal barcode identifier to a travel itinerary of the user;
looking up information about the user when the personal universal barcode identifier is entered into a database search request; and
tracking each time the check-in bags are scanned during a travel itinerary.
